(19) United States
(12) Patent Application Publication
(10) Pub. No.: US 2006/0108911 A1
(43) Pub. Date: May 25, 2006

(54) Surface light source device and backlight unit having the same

(75) Inventors: Hyun-Sook Kim, Seoul (KR); Jae-Seok Park, Seoul (KR); Kil-Ho Kim, Suwon-si (KR); Seog-Hyun Cho, Seoul (KR)

Correspondence Address: MAYER, BROWN, ROWE & MAW LLP, 1909 K STREET, N.W., WASHINGTON, DC, 20006, US

(73) Assignee: SAMSUNG CORNING CO., LTD.

(21) Appl. No.: 11/271,753

(22) Filed: Nov. 14, 2005

(30) Foreign Application Priority Data
Nov. 24, 2004 (KR) 10-2004-96821
Sep. 27, 2005 (KR) 10-2005-89802

(51) Int. Cl. H01J 1/62

(52) U.S. Cl. 313/493

(57) ABSTRACT

A surface light source device includes a light source body having a plurality of discharge spaces that are divided into a light-emitting region and a non-light-emitting region. The light-emitting region has a first cross sectional area. The non-light-emitting region has a second cross sectional area larger than the first cross sectional area. An electrode for applying a voltage to a discharge gas, which is injected into the discharge spaces, is provided to a portion of the light source body corresponding to the non-light-emitting region. Thus, a larger amount of the discharge gas may be distributed in the non-light-emitting region than in the light-emitting region. As a result, the electrode may not serve as a dark field. Further, the surface light source device may have a long life span.

### CROSS-REFERENCE TO RELATED APPLICATION

This application claims priority under 35 USC §119 to Korean Patent Applications Nos. 2004-96821, filed on Nov. 24, 2004, and 2005-89802, filed on Sep. 27, 2005, the contents of which are herein incorporated by reference in their entireties for all purposes.

### BACKGROUND OF THE INVENTION

1. Field of the Invention

The present invention relates to a surface light source device and a backlight unit having the same. More particularly, the present invention relates to a surface light source device for emitting a planar light, and a backlight unit having the surface light source device as a light source.

2. Description of the Related Art

Generally, a liquid crystal (LC) has electrical and optical characteristics. In detail, when electric fields applied to the LC are changed, an arrangement of the LC molecules is also changed. As a result, an optical transmittance is altered.

A liquid crystal display (LCD) apparatus uses the above-explained characteristics of the LC to display an image. The LCD apparatus has many merits, for example, such as a small volume, a lightweight, etc. Therefore, the LCD apparatus is used in various fields, for example, such as a notebook computer, a mobile phone, a television set, etc.

The LCD apparatus includes a liquid crystal controlling part and a light providing part. The liquid crystal controlling part controls the LC. The light providing part provides the liquid crystal controlling part with a light.

The liquid crystal controlling part includes a pixel electrode formed on a first substrate, a common electrode formed on a second substrate and a liquid crystal layer interposed between the pixel electrode and the common electrode. A number of the pixel electrode is determined in accordance with resolution, and a number of the common electrode is one. Each of the pixel electrodes is electrically connected to a thin film transistor (TFT), so that a pixel voltage is applied to the pixel electrode through the TFT. A reference voltage is applied to the common electrode. Both of the pixel electrode and the common electrode include an electrically conductive and optically transparent material.

The light providing part provides the liquid crystal controlling part with a light. The light generated from the light providing part passes through the pixel electrode, the liquid crystal layer and the common electrode in sequence. Therefore, luminance and uniformity of the luminance have great influence on a display quality of the LCD apparatus.

A conventional light providing part employs a cold cathode fluorescent lamp (CCFL) or a light emifting diode (LED). The CCFL has a long cylindrical shape, whereas the LED has a small dot shape.

The CCFL has high luminance and long lifespan, and generates a small amount of heat. The LED has relatively high power consumption but a better color reproductibility. However, both of the CCFL and the LED have low uniformity of luminance.

Therefore, in order to enhance the luminance uniformity, the light providing part requires optical members such as a light guide plate (LGP), a diffusion member, a prism sheet, etc. Therefore, both of volume and weight of the LCD apparatus increase.

In order to solve above-mentioned problem, a surface light source device has been developed. The surface light source device may be classified into a partition wall-separated type device and a partition-integrated type device.

A conventional partition wall-separated type surface light source device includes first and second substrates spaced apart from each other, and a plurality of partition walls interposed between the first and second substrates. The partition walls are arranged substantially in parallel with each other to define a plurality of discharge spaces into which a discharge gas is injected. A sealing member is interposed between the first and second substrates to isolate the discharge spaces from the exterior. Fluorescent layers are formed on inner faces of the first and second substrates. Electrodes for applying a voltage to the discharge gas are provided to an edge portion of the first and second substrates or in the first and second substrates.

On the contrary, a conventional partition wall-integrated surface light source device includes a first substrate and a second substrate having partition wall portions integrally formed therewith. Outermost partition wall portions are attached to the first substrate using a sealing frit to form a plurality of discharge spaces into which a discharge gas is injected. Fluorescent layers are formed on inner faces of the first and second substrates. Electrodes for applying a voltage to the discharge gas are provided to an edge portion of the first and second substrates or in the first and second substrates.

In the above-mentioned conventional surface light source devices, to provide the discharge gas to the discharge spaces, the discharge spaces are in communications with each other. For example, to provide passageways of the discharge gas to the partition walls, the partition walls are arranged in a serpentine shape or holes are formed through the partition walls.

However, in the conventional surface light source devices, a non-light-emitting region covered by the electrode has a width and a height substantially identical to those of a light-emitting region that is not covered by the electrode. The non-light-emitting region and the light-emitting region have a tubular current for lighting the surface light source device. In general, to provide the surface light source device with a high luminance using a proper tubular current, thin thicknesses of the first and second substrates are required. When the thicknesses of the first and second substrates are too thick, heat generated from plasma in the discharge spaces is slowly transmitted compared to that of a surface light source device including relatively thin substrates. Thus, the surface light source device including the thick substrates has a low luminance. However, although the surface light source device has an improved luminance proportional to reducing thicknesses of the substrates, there is a limit to reduce the thicknesses of the substrates.

Further, in the conventional surface light source devices, outermost discharge spaces adjacent to the exterior are cooled faster than the rest of the discharge spaces so that the outermost discharge spaces have a luminance lower than that of the rest of the discharge spaces.

### SUMMARY OF THE INVENTION

The present invention provides a surface light source device that has a uniform luminance by generating a large amount of secondary electrons in a non-light-emitting region.

The present invention also provides a backlight unit having the above-mentioned surface light source device.

A surface light source device in accordance with one aspect of the present invention includes a light source body having a plurality of discharge spaces that are divided into a light-emitting region and a non-light-emitting region. The light-emitting region has a first cross sectional area. The non-light-emitting region has a second cross sectional area larger than the first cross sectional area. An electrode for applying a voltage to a discharge gas, which is injected into the discharge spaces, is provided to a portion of the light source body corresponding to the non-light-emitting region.

According to one embodiment, the non-light-emitting region may have a width wider than that of the light-emitting region. The non-light-emitting region may have a height higher than that of the light-emitting region. The non-light-emitting region may have a width and a height greater than those of the light-emitting region. In addition, outermost discharge spaces among the discharge spaces have a third cross sectional area larger than the second cross sectional area.

According to another embodiment, the electrode may be formed on both outer faces of the light source body. An auxiliary electrode may extend from edge portions of the electrode to provide the edge portions of the electrode with a width wider than that of a central portion of the electrode.

According to still another embodiment, the light source body includes a first substrate, a second substrate positioned over the first substrate, a sealing member interposed between edge portions of the first and second substrates to define an inner space, and partition walls arranged in the inner space to form the discharge spaces. A space-expanding portion is upwardly formed at a portion of the second substrate corresponding to the non-light-emitting region to provide the non-light-emitting region with the second cross sectional area. Alternatively, a space-expanding portion may be downwardly formed at a portion of the first substrate corresponding to the non-light-emitting region. In addition, a second space-expanding portion is formed at both end portions of the first substrate and/or the second substrate that define the outermost discharge spaces to provide the non-light-emitting region in the outermost discharge spaces with the third cross sectional area wider than the second cross sectional area.

According to further still another embodiment, the light source body includes a first substrate, and a second substrate integrally formed with partition wall portions that make contact with the first substrate to form the discharge spaces. A space-expanding portion is upwardly formed at a portion of the second substrate corresponding to the non-light-emitting region to provide the non-light-emitting region with the second cross sectional area. Alternatively, a space-expanding portion may be downwardly formed at a portion of the first substrate corresponding to the non-light-emitting region. In addition, a second space-expanding portion is formed at both end portions of the first substrate and/or the second substrate that define the outermost discharge spaces to provide the non-light-emitting region in the outermost discharge spaces with the third cross sectional area wider than the second cross sectional area.

A surface light source device in accordance with another aspect of the present invention includes a light source body having central discharge spaces and outermost discharge spaces into which a discharge gas is injected. Each of the central discharge spaces includes a central light-emitting region and a non-light-emitting region having a width substantially identical to that of the central light-emitting region. Each of the outermost discharge spaces includes an outermost light-emitting region having a first cross sectional area and an outermost non-light-emitting region having a second cross sectional area larger than the first cross sectional area. An electrode for applying a voltage to the discharge gas is provided to the light source body.

A backlight unit in accordance with still another aspect of the present invention includes a surface light source device, a case for receiving the surface light source device, an optical sheet interposed between the surface light source device and the case, and an inverter for applying a discharge voltage to the surface light source device. The surface light source device includes a light source body having a plurality of discharge spaces that are divided into a light-emitting region and a non-light-emitting region. The light-emitting region has a first cross sectional area. The non-light-emitting region has a second cross sectional area larger than the first cross sectional area. An electrode for applying a voltage to a discharge gas, which is injected into the discharge spaces, is provided to a portion of the light source body corresponding to the non-light-emitting region.

According to the present invention, the non-light-emitting region has the cross sectional area larger than that of the light-emitting region so that the discharge gas may be more distributed in the non-light-emitting region. Thus, the electrode may not serve as a dark field. Further, the surface light source device may have a long life span.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a perspective view illustrating a surface light source device in accordance with a first example embodiment of the present invention;

FIG. 2 is a cross sectional view taken along a line IIa-IIb in FIG. 1;

FIG. 3 is a cross sectional view taken along a line IIIa-IIIb in FIG. 1;

FIG. 4 is a plan view illustrating an arrangement of partition walls on a first substrate;

FIG. 5 is a perspective view illustrating a surface light source device in accordance with a second example embodiment of the present invention;

FIG. 6 is a cross sectional view taken along a line VIa-VIb in FIG. 5;

FIG. 7 is a cross sectional view taken along a line VIIa-VIIb in FIG. 5;

FIG. 8 is a perspective view illustrating a surface light source device in accordance with a third example embodiment of the present invention;

FIG. 9 is a cross sectional view taken along a line IXa-IXb in FIG. 8;

FIG. 10 is a cross sectional view taken along a line Xa-Xb in FIG. 8;

FIG. 11 is a plan view illustrating an arrangement of partition wall portions on a first substrate;

FIG. 12 is a perspective view illustrating a surface light source device in accordance with a fourth example embodiment of the present invention;

FIG. 13 is a cross sectional view taken along a line XIIIa-XIIIb in FIG. 12;

FIG. 14 is a cross sectional view taken along a line XIVa-XIVb in FIG. 12;

FIG. 15 is a plan view illustrating a surface light source device in accordance with a fifth example embodiment of the present invention;

FIG. 16 is a plan view illustrating a surface light source device in accordance with a sixth example embodiment of the present invention; and

FIG. 17 is an exploded perspective view illustrating a backlight unit in accordance with a seventh embodiment of the present invention.

### DESCRIPTION OF EMBODIMENTS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of elements and regions may be exaggerated for clarity.

It will be understood that when an element or layer is referred to as being “on”, “connected to” or “coupled to” another element, it can be directly on, connected or coupled to the other element or layer or intervening elements may be present. In contrast, when an element is referred to as being “directly on,” “directly connected to” or “directly coupled to” another element, there are no intervening elements present. Like numbers refer to like elements throughout. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another element. Thus, a first element discussed below could be termed a second element without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### Embodiment 1

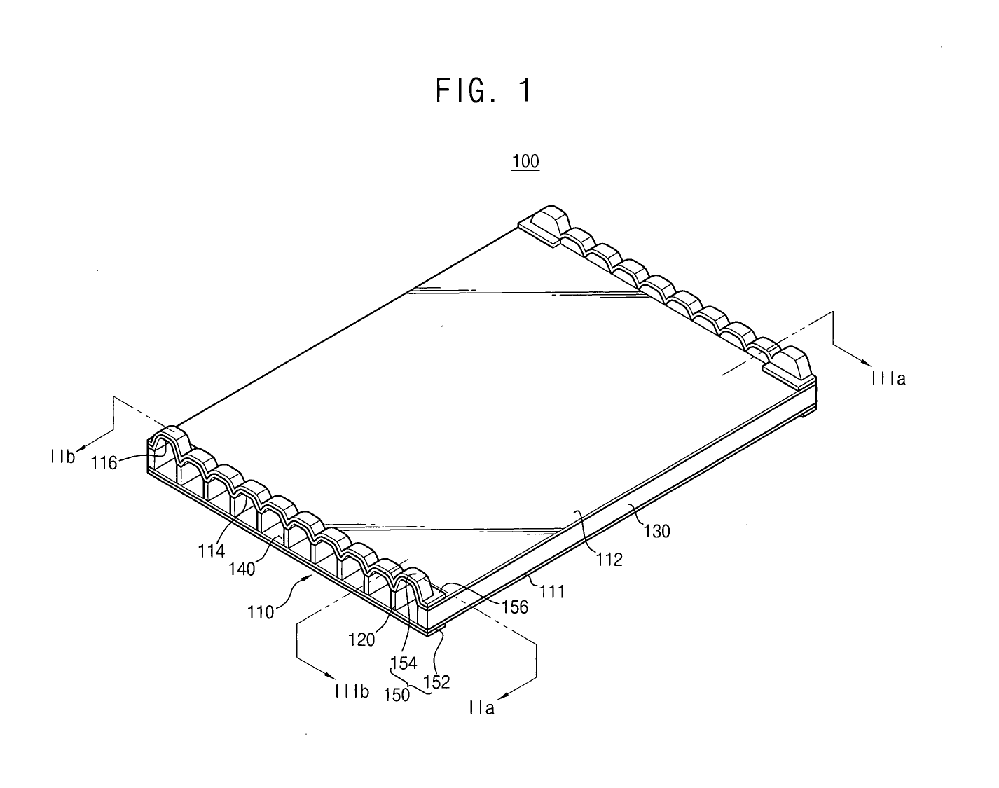

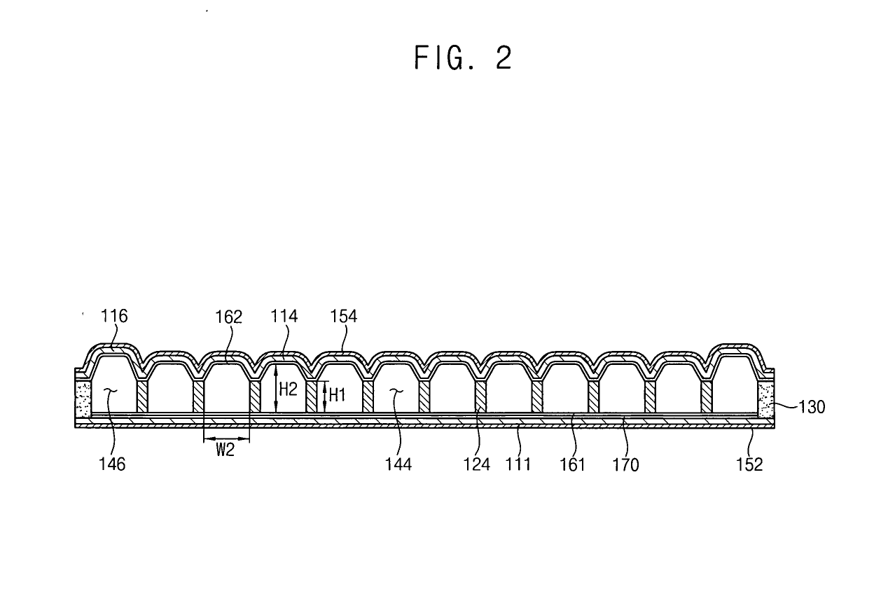

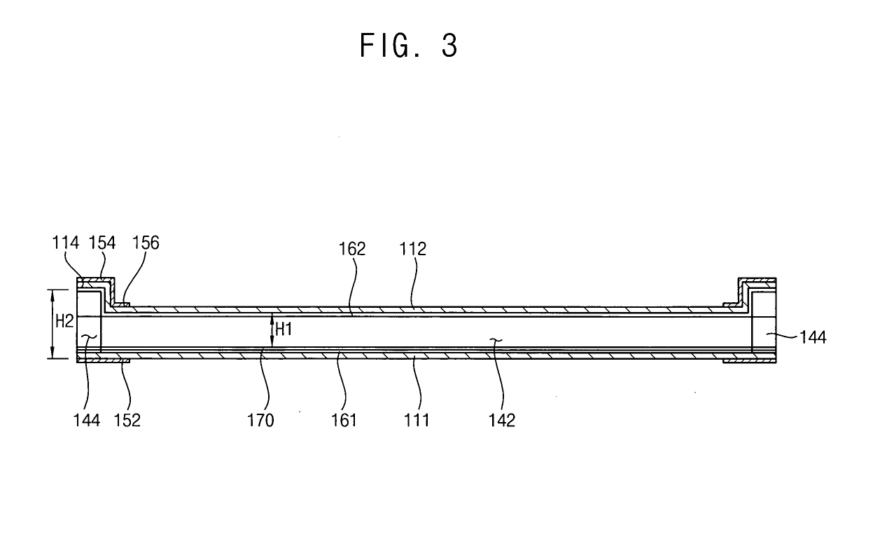

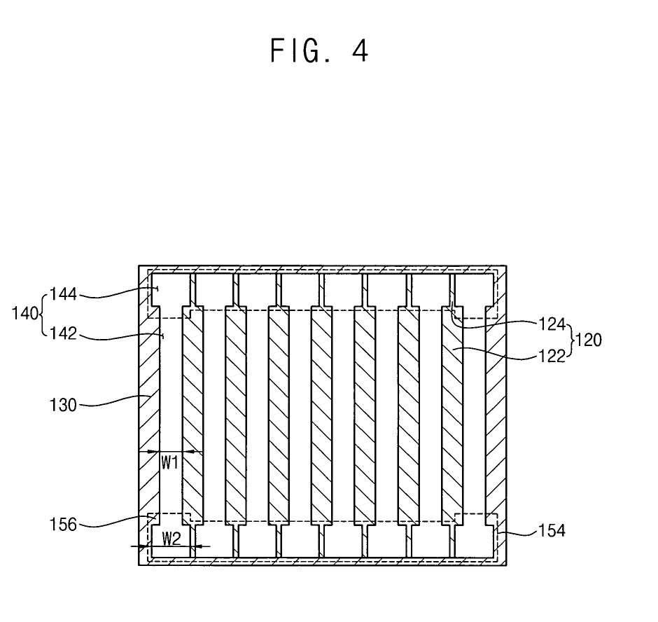

FIG. 1 is a perspective view illustrating a surface light source device in accordance with a first example embodiment of the present invention, FIG. 2 is a cross sectional view taken along a line IIa-IIb in FIG. 1, FIG. 3 is a cross sectional view taken along a line IIIa-IIIb in FIG. 1, and FIG. 4 is a plan view illustrating an arrangement of partition walls on a first substrate.

Referring to FIGS. 1 to 4, a surface light source device 100 in accordance with the present embodiment includes a light source body 110 having an inner space into which a discharge gas is injected, and an electrode 150 for applying a voltage to the discharge gas. Here, examples of the discharge gas are a mercury gas, an argon gas, a neon gas, a xenon gas, etc.

The light source body 110 is a partition wall-separated type. Thus, the light source body 110 includes a first substrate 111 and a second substrate 112 positioned over the first substrate 111. A sealing member 130 is interposed between edge portions of the first and second substrates 111 and 112 to define the inner space. Partition walls 120 are arranged in the inner space to divide the inner space into discharge spaces 140.

The first and second substrates 111 and 112 include a glass that is capable of transmitting a visible light therethrough and blocking an ultraviolet ray. The second substrate 112 corresponds to a light-exiting face through which a light generated in the inner space exits.

The partition walls 120 are arranged in a first direction and substantially in parallel with each other to form the discharge spaces 140 having a stripe shape. Each of the partition walls 120 includes a lower face making contact with the first substrate 111 and an upper face making contact with the second substrate 112. To provide the discharge gas to each of the discharge spaces 140, the partition walls 120 may be arranged in a serpentine shape. Alternatively, a hole (not shown) through which the discharge gas flows may be formed through the partition walls 120.

The electrode 150 includes a first electrode 152 formed beneath a lower face of the first substrate 111 and a second electrode 154 formed on an upper face of the second substrate 112. The first and second electrodes 152 and 154 are arranged on both edge portions of the first and second substrates 111 and 112 in a second direction substantially perpendicular to the first direction. The electrode 150 may include a conductive tape or a metal powder such as copper (Cu), nickel (Ni), silver (Ag), gold (Au), aluminum (Al), chromium (Cr), etc.

Each of the discharge spaces 140 is divided into a non-light-emitting region 144 that is covered by the electrode 150, and a light-emitting region 142 that is not covered by the electrode 150. As described above, since the electrode 150 is provided on the both edge portions of the first and second substrates 111 and 112, the non-light-emitting region 144 corresponds to both edge spaces of the discharge space 140. The light-emitting region 142 corresponds to a central space of the discharge space 140 except for the both edge spaces. That is, the light-emitting region 142 and the non-light-emitting region 144 may vary in accordance with positions of the electrode 150.

Space-expanding portions 114 are upwardly formed from the upper face of the second substrate 112. The space-expanding portions 114 of the present embodiment have a semi-circular cross section. Alternatively, the space-expanding portions 114 may have a rectangular cross section, a trapezoid cross section, a triangular cross section, etc. The space-expanding portions 114 have a width substantially identical to that of the electrode 150. Thus, the space-expanding portions 114 are formed at both edges of the upper face of the second substrate 112 corresponding to the non-light-emitting region 144.

Therefore, the light-emitting region 142 has a first width W1 and a first height H1. The non-light-emitting region 144 has a second width W2 wider than the first width W1 and a second height H2 higher than the first height H1. The second height H2 of the non-light-emitting region 144 is higher than the first height H1 of the light-emitting region 142 by a height of the space-expanding portions 114 protruded from the second substrate 112.

Each of the partition walls 120 includes a first partition wall portion 122 in the light-emitting region 142, and a second partition wall portion 124 in the non-light-emitting region 144 having a width narrower than that of the first partition wall portion 122. In the present embodiment, an interface between the first partition wall portion 122 and the second partition wall portion 124 is substantially perpendicular to the first direction. Alternatively, the interface may be a tapered shape. When the interface has the tapered shape, the width of the second partition wall portion 124 is gradually reduced from the width of the first partition wall portion 122.

As described above, since the non-light-emitting region 144 has the second height H2 a nd the second width W2 greater than the first height H1 and the first width W1 of the light-emitting region 142, the non-light-emitting region 144 has the second cross sectional area larger than the first cross sectional area of the light-emitting region 142. Thus, a large amount of the discharge gas is distributed in the non-light-emitting region 144 than that in a non-light-emitting region of a conventional surface light source device that includes the non-light-emitting region and a light-emitting region, which have cross sectional areas substantially identical to each other. As a result, much more secondary electrons may be generated in the non-light-emitting region 144 so that the electrode 150 may not act as a dark field of the surface light source device 100. Further, a reduction amount of the mercury gas in the non-light-emitting region 144 may be decreased so that the surface light source device 100 may have a long life span.

In the present embodiment, the non-light-emitting region 144 has the height and the width greater than those of the light-emitting region 142 so that the non-light-emitting region 144 has the second cross sectional area larger than the first cross sectional area of the light-emitting region 142. Alternatively, the non-light-emitting region 144 may have a height substantially identical to the first height H1 of the light-emitting region 142 and the second width W2 wider than the first width W1 of the light-emitting region 142. Further, the non-light-emitting region 144 may have a width substantially identical to the first width W1 of the light-emitting region 142 and the second height H2 higher than the first height H1 of the light-emitting region 142.

Since the second electrode 154 is formed along the space-expanding portions 114, the second electrode 154 has an arched shape corresponding to a shape of the space-expanding portions 114. On the contrary, the first electrode 152 has a flat shape.

Here, outermost discharge spaces among the discharge spaces 140 are isolated from the exterior using only the sealing member 130. Thus, a thermal exchange between the outermost discharge spaces and the exterior actively occurs so that the discharge gas in the outermost discharge spaces is cooled faster than that in other discharge spaces 140. As a result, the outermost discharge spaces may have light-emitting efficiency lower than that of other discharge spaces 140. Particularly, when the outermost discharge spaces have the relatively large cross sectional area, the outermost discharge spaces may have much lowered light-emitting efficiency.

To overcome the above-mentioned problem, auxiliary electrode portions 156 extend from both ends of the first and second electrode 152 and 154, which are positioned over outermost non-light-emitting regions 146, in the first direction. The auxiliary electrode portions 156 apply a voltage higher than that applied to the discharge gas in the non-light-emitting region 144 to the discharge gas in the outermost non-light-emitting regions 146. Thus, the outermost non-light-emitting regions 146 may have improved light-emitting efficiency.

In addition, auxiliary space-expanding portions 116 are upwardly formed at the both ends of the second substrate 112 that define the outermost non-light-emitting regions 146. The auxiliary space-expanding portions 116 have a height higher than that of the space-expanding portions 114. Thus, the outermost discharge spaces have a third cross sectional area larger than the second cross sectional area of central non-light-emitting regions among the non-light-emitting regions 144 so that much larger amount of the discharge gas is distributed in the outermost non-light-emitting regions 146 than that in the central non-light-emitting regions. As a result, the outermost non-light-emitting regions 146 may have a luminance substantially similar to that of the central non-light-emitting regions.

A light-reflecting layer 170 is formed on the first substrate 111. The light-reflecting layer 170 reflects a light, which orients toward the first substrate 111, toward the second substrate 112. A first fluorescent layer 161 is formed on the light-reflecting layer 170. A second fluorescent layer 162 is formed beneath the second substrate 112.

### Embodiment 2

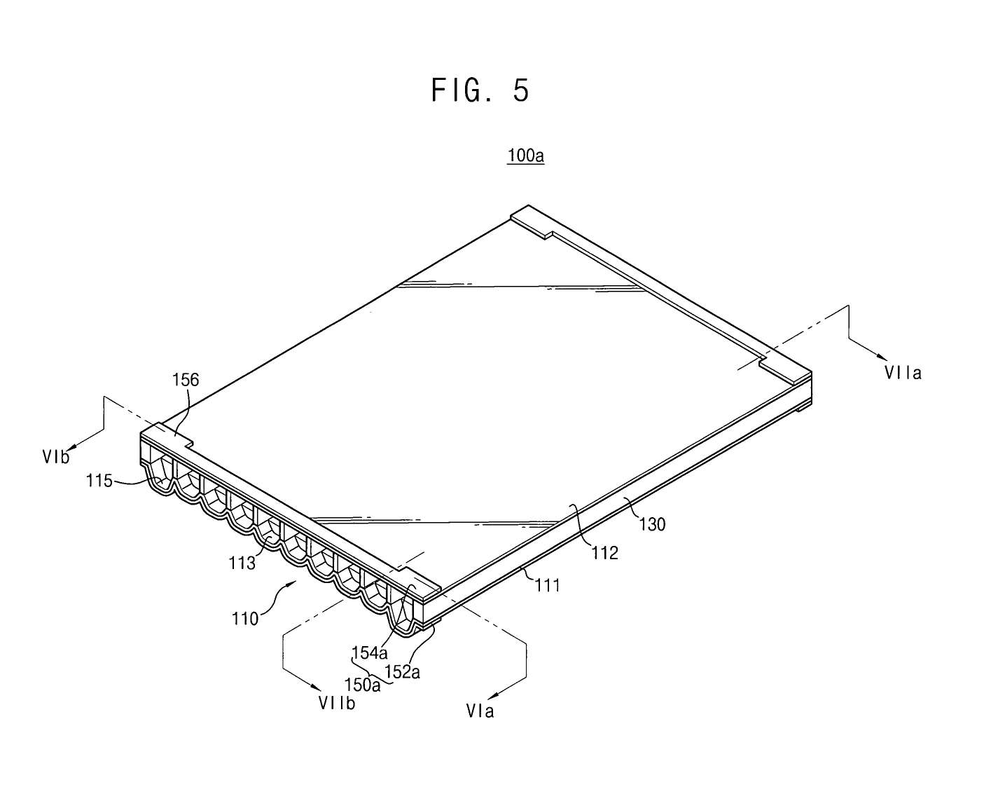

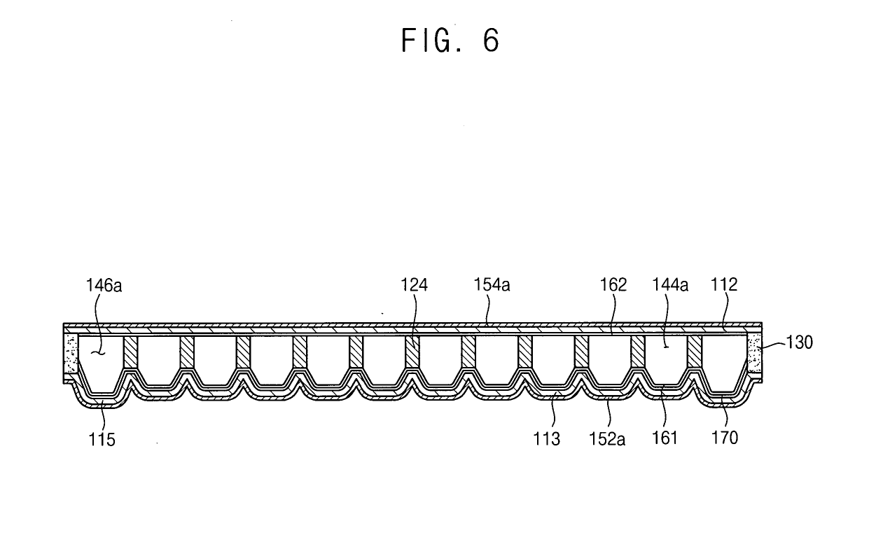

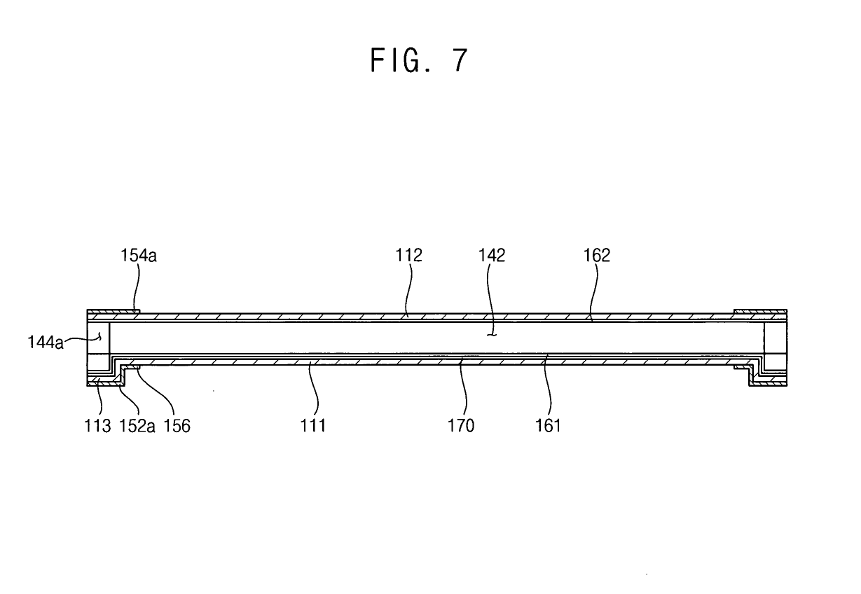

FIG. 5 is a perspective view illustrating a surface light source device in accordance with a second example embodiment of the present invention, FIG. 6 is a cross sectional view taken along a line VIa-VIb in FIG. 5, and FIG. 7 is a cross sectional view taken along a line VIIa-VIIb in FIG. 5.

A surface light source device 100a of the present embodiment includes elements substantially identical to those in the surface light source device 100 in Embodiment 1 except for positions of space-expanding portions. Thus, same reference numerals refer to same elements and any further illustrations with respect to the same elements are omitted herein.

Referring to FIGS. 5 to 7, space-expanding portions 113 are downwardly formed at both ends of the first substrate 111 in the first direction. The space-expanding portions 113 are positioned at the both ends of the first substrate 111 corresponding to a non-light-emitting region 144a of the discharge space 140 so that the non-light-emitting region 144a has a cross sectional area larger than that of the light-emitting region 142. Since the space-expanding portions 113 are provided to the non-light-emitting region 144a, the non-light-emitting region 144a has greater height and width compared to those of the light-emitting region 142. Alternatively, the non-light-emitting region 144a may have a width substantially identical to that of the light-emitting region 142 and the height higher than that of the light-emitting region 142.

In addition, auxiliary space-expanding portions 115 are downwardly formed at the both ends of the first substrate 111, which define outermost non-light-emitting regions 146a, in the second direction. Thus, the outermost discharge spaces 146a have a cross sectional area larger than that of central non-light-emitting regions.

An electrode 150a for defining the non-light-emitting region 144a includes a first electrode 152a formed beneath the first substrate 111, and a second electrode 154a formed on the second substrate 112. Since the space-expanding portions 113 are formed at the first substrate 111, the first electrode 152a has an arched shape corresponding to a shape of the space-expanding portions 113. On the contrary, the second electrode 154a has a flat shape.

Here, in Embodiments 1 and 2, the space-expanding portions are provided to any one of the first substrate 111 and the second substrate 112. Alternatively, the space-expanding portions 113 may be provided to the first and second substrates 111 and 112.

### Embodiment 3

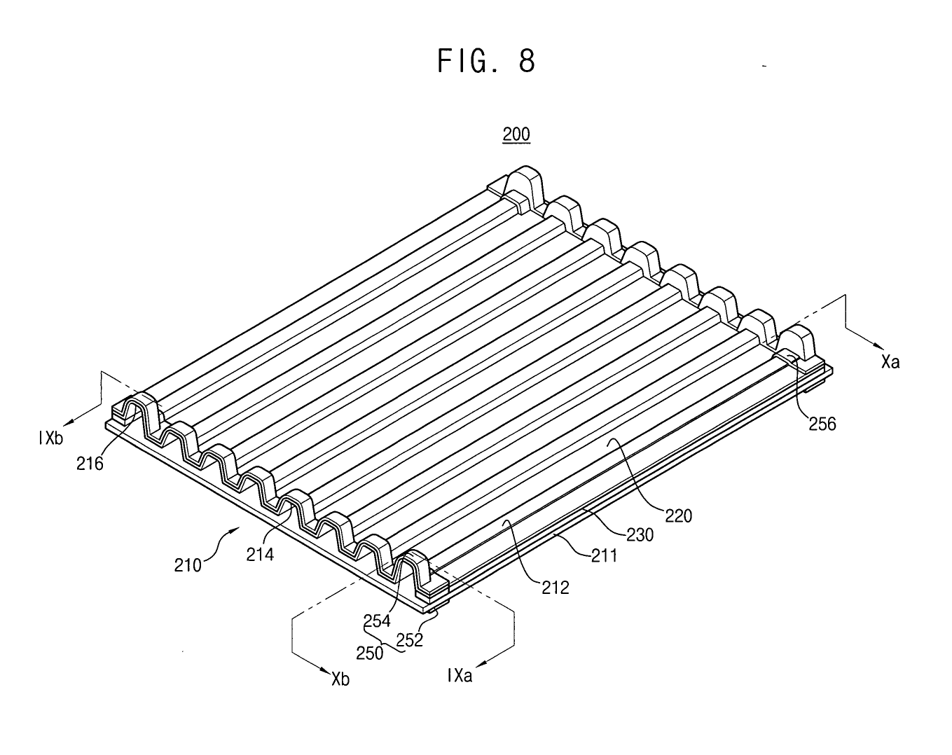

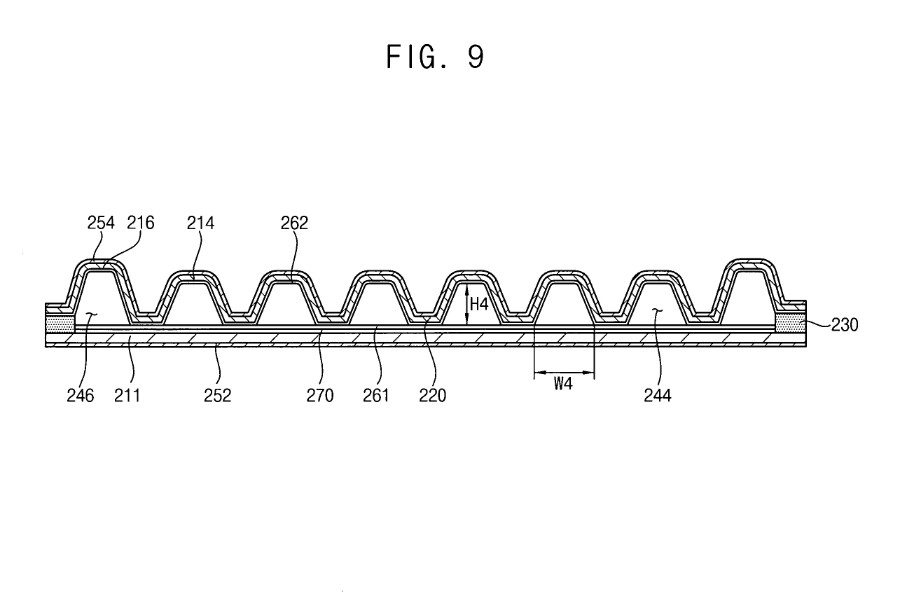

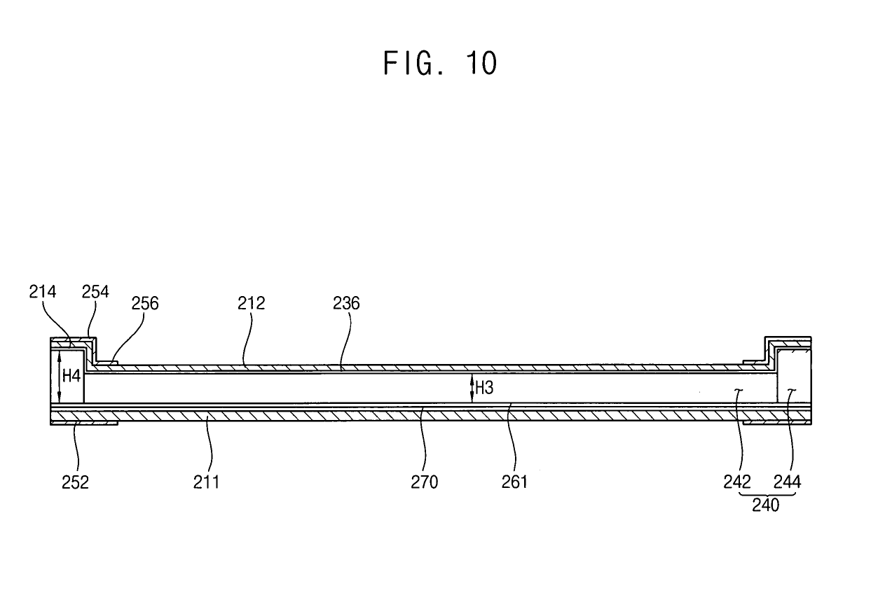

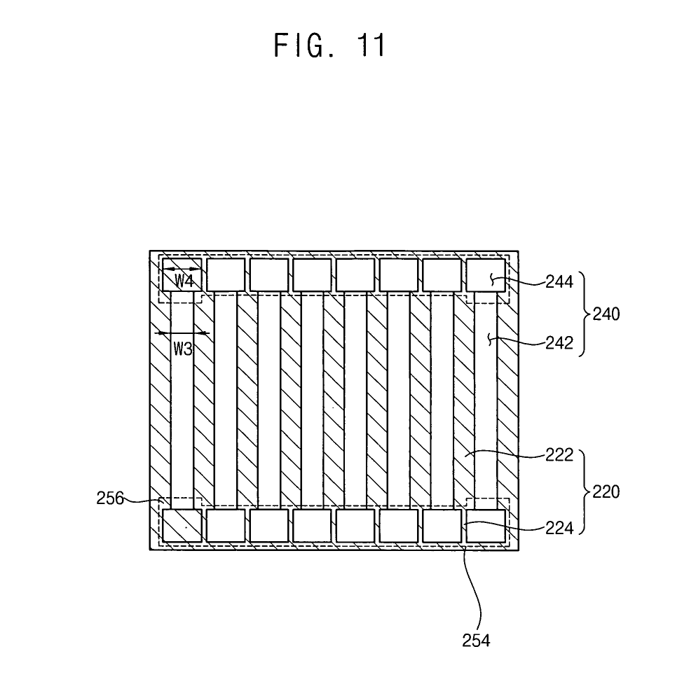

FIG. 8 is a perspective view illustrating a surface light source device in accordance with a third example embodiment of the present invention, FIG. 9 is a cross sectional view taken along a line IXa-IXb in FIG. 8, FIG. 10 is a cross sectional view taken along a line Xa-Xb in FIG. 8, and FIG. 11 is a plan view illustrating an arrangement of partition wall portions on a first substrate.

Referring to FIGS. 8 to 11, a surface light source device 200 in accordance with the present embodiment includes a light source body 210 having an inner space into which a discharge gas is injected, and an electrode 250 for applying a voltage to the discharge gas.

The surface light source device 200 is a partition wall-integrated type. Thus, the light source body 210 includes a first substrate 211, and a second substrate 212 positioned over the first substrate 211 and integrally formed with partition wall portions 220. The partition wall portions 220 make contact with the first substrate 211 to form a plurality of arched discharge spaces 240. To provide the discharge gas to each of the discharge spaces 240, the partition wall portions 220 may be arranged in a serpentine shape. Alternatively, a connection hole (not shown) through which the discharge gas flows may be formed through the partition wall portions 220. The connection hole may have an inclined shape or an “S” shape. In the present embodiment, each of the partition wall portions 220 has a width of about 1 mm to about 5 mm.

The electrode 250 is arranged on both edge portions of the light source body 210 in the second direction substantially perpendicular to the first direction. The electrode 250 includes a first electrode 252 formed beneath a lower face of the first substrate 211 and a second electrode 254 formed on an upper face of the second substrate 212.

Each of the discharge spaces 240 is divided into a non-light-emitting region 244 that is covered by the electrode 250, and a light-emitting region 242 that is not covered by the electrode 250. Auxiliary electrode portions 256 extend from both ends of the first and second electrode 252 and 254, which are positioned over outermost non-light-emitting regions 244, in the first direction.

Space-expanding portions 214 are upwardly formed from both ends of an upper face of the second substrate 212. The space-expanding portions 214 have a width substantially identical to that of the electrode 250.

Therefore, the light-emitting region 242 has a third width W3 and a third height H3. The non-light-emitting region 244 has a fourth width W4 wider than the third width W3 and a fourth height H4 higher than the third height H3. Particularly, the fourth width W4 of the non-light-emitting region 244 is formed by reducing the partition wall portion 220 in the non-light-emitting region 244. Thus, each of the partition wall portions 220 includes a first partition wall portion 222 in the light-emitting region 242, and a second partition wall portion 224 in the non-light-emitting region 244 having a width narrower than that of the first partition wall portion 222.

In addition, auxiliary space-expanding portions 216 are upwardly formed at the both ends of the second substrate 212, which define the outermost non-light-emitting regions 246. The auxiliary space-expanding portions 216 have a height higher than that of the space-expanding portions 214.

Alternatively, the non-light-emitting region 244 may have a height substantially identical to the third height H3 of the light-emitting region 242 and the fourth width W4 wider than the third width W3 of the light-emitting region 242. Further, the non-light-emitting region 244 may have a width substantially identical to the third width W3 of the light-emitting region 242 and the fourth height H4 higher than the third height H3 of the light-emitting region 242.

A light-reflecting layer 270 is formed on the first substrate 211. A first fluorescent layer 261 is formed on the light-reflecting layer 270. A second fluorescent layer 262 is formed beneath the second substrate 212.

### Embodiment 4

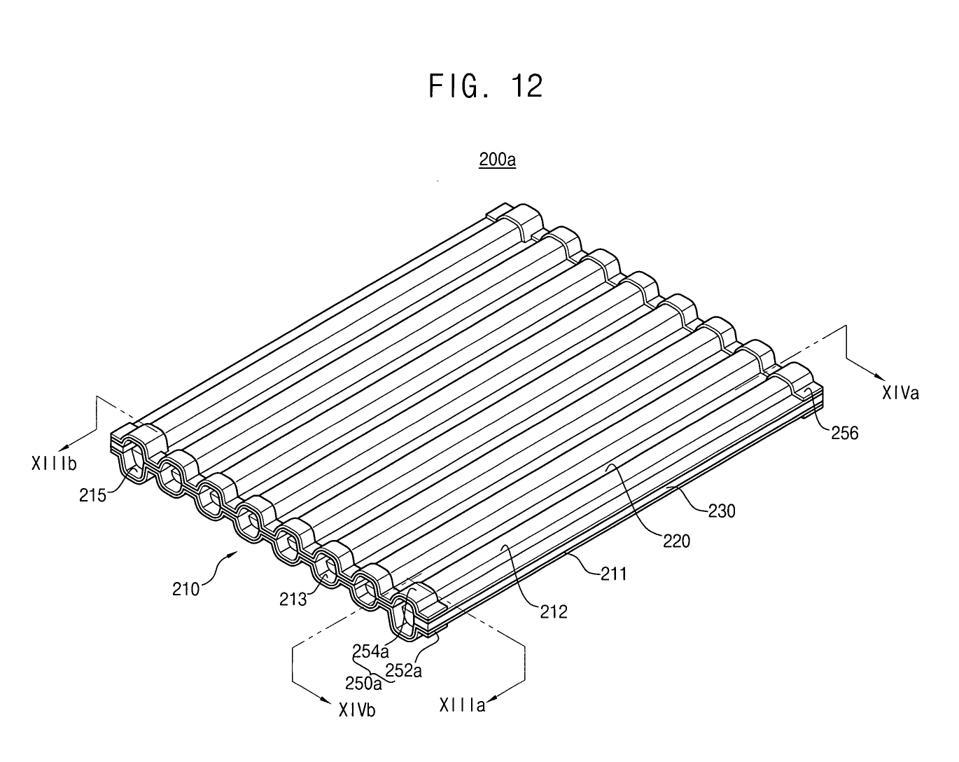

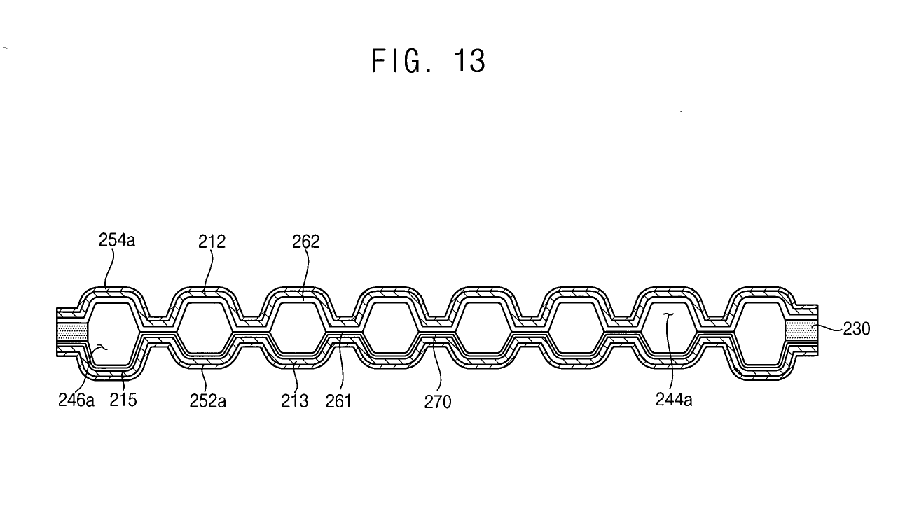

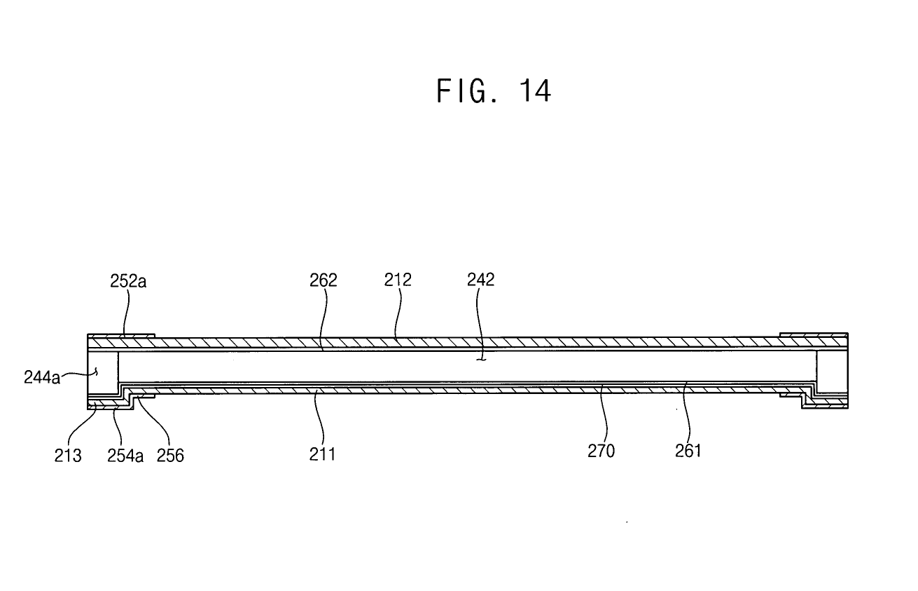

FIG. 12 is a perspective view illustrating a surface light source device in accordance with a fourth example embodiment of the present invention, FIG. 13 is a cross sectional view taken along a line XIIIa-XIIIb in FIG. 12, and FIG. 14 is a cross sectional view taken along a line XIVa-XIVb in FIG. 12.

A surface light source device 200a of the present embodiment includes elements substantially identical to those in the surface light source device 200 in Embodiment 3 except for positions of space-expanding portions. Thus, same reference numerals refer to same elements and any further illustrations with respect to the same elements are omitted herein.

Referring to FIGS. 12 to 14, space-expanding portions 213 are downwardly formed at both ends of the first substrate 211 in the first direction. Since the space-expanding portions 213 are provided to a non-light-emitting region 244a, the non-light-emitting region 244a has greater height and width compared to those of the light-emitting region 242. Alternatively, the non-light-emitting region 244a may have a width substantially identical to that of the light-emitting region 242 and the height higher than that of the light-emitting region 242. In addition, auxiliary space-expanding portions 215 are downwardly formed at the both ends of the first substrate 211, which define outermost non-light-emitting regions 246a, in the second direction.

An electrode 250a for defining the non-light-emitting region 244a includes a first electrode 252a formed beneath the first substrate 211, and a second electrode 254a formed on the second substrate 212.

Here, in Embodiments 3 and 4, the space-expanding portions are provided to any one of the first substrate 211 and the second substrate 212. Alternatively, the space-expanding portions may be provided to the first and second substrates 211 and 212.

The electrodes of the present invention are not restricted within the surface light source devices in Embodiments. The electrodes may be employed in other surface light source devices having various shapes.

### Embodiment 5

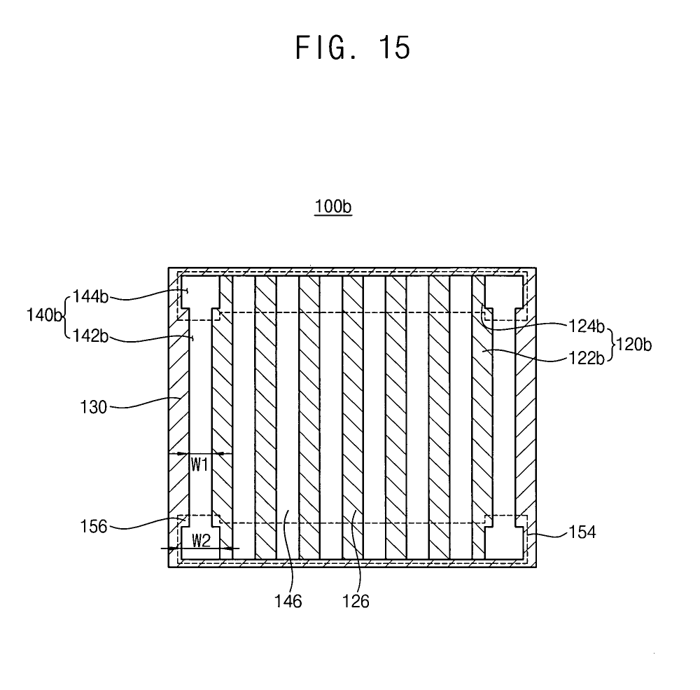

FIG. 15 is a plan view illustrating a surface light source device in accordance with a fifth example embodiment of the present invention.

A surface light source device 100b of the present embodiment includes elements substantially identical to those in the surface light source device 100 in Embodiment 1 except for shapes of discharge spaces. Thus, same reference numerals refer to same elements and any further illustrations with respect to the same elements are omitted herein.

Referring to FIG. 15, the surface light source device 100b of the present embodiment includes central partition walls 126 for defining central discharge spaces 146, and outermost partition walls 120b for defining outermost discharge spaces 140b.

Each of the central partition walls 126 has a substantially same width. Thus, each of the central discharge spaces 146 defined by the central partition walls 126 has a substantially same width. As a result, each of the central discharge spaces 146 includes a central light-emitting region and a central non-light-emitting region having a width substantially identical to that of the central light-emitting region.

On the contrary, each of the outermost partition walls 120b includes a first partition wall portion 122b in an outermost light-emitting region 142b, and a second partition wall portion 124b in an outermost non-light-emitting region 144b and having a width narrower than that of the first partition wall portion 122b.

That is, space-expanding portions are provided to both outermost ends of the second substrate. Particularly, the space-expanding portions in Embodiment 1 are provided to the both ends of the second substrate. On the contrary, the space-expanding portions of the present embodiment are not provided to both central ends of the second substrate and are only provided to the both outermost ends of the second substrate. Further, the space-expanding portions are formed at an inner face of the sealing member 130 and an outer face of the second partition wall portion 124b. Thus, the central discharge spaces 146 do not have the space-expanding portions. Only the outermost discharge spaces 140b have the space-expanding portions.

Therefore, each of the central discharge spaces 146 has the light-emitting region and the non-light-emitting region having a width substantially identical to that of the light-emitting region. On the contrary, each of the outermost discharge spaces 140b having the space-expanding portions includes the outermost light-emitting region 142b having a first width W1, and the outermost non-light-emitting region 144b having a second width W2 wider than the first width W1. Alternatively, the outermost non-light-emitting region 144b may have a second height higher than a first height of the outermost light-emitting region 142b.

Here, in the present embodiment, the partition wall-separated type surface light source device 100b is exemplarily illustrated. Alternatively, the surface light source device 100b may correspond to the partition wall-integrated type. Further, the above-mentioned structures in Embodiments may be employed in the space-expanding portions of the present embodiment.

### Embodiment 6

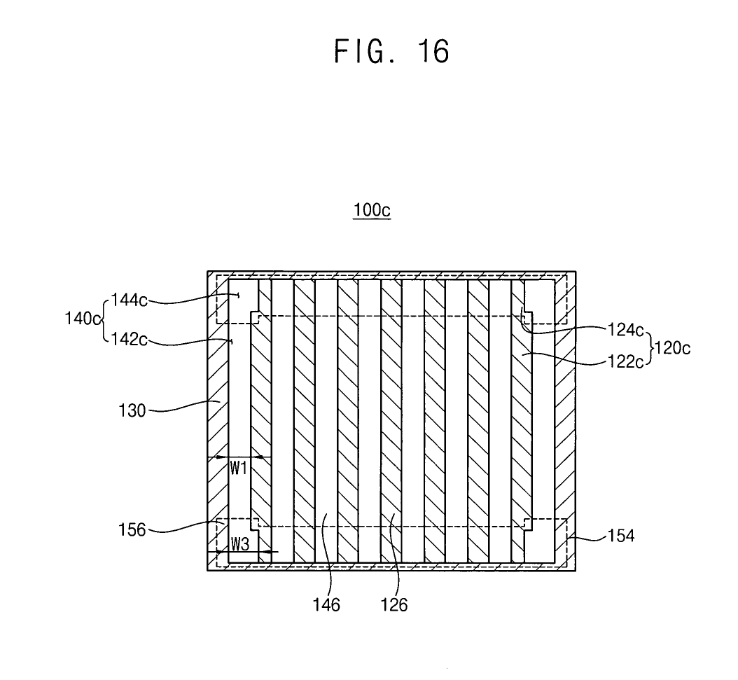

FIG. 16 is a plan view illustrating a surface light source device in accordance with a sixth example embodiment of the present invention.

A surface light source device 100c of the present embodiment includes elements substantially identical to those in the surface light source device 100b in Embodiment 5 except for shapes of outermost discharge spaces. Thus, the same reference numerals are used to refer to same elements and any further explanations with respect to the same elements are omitted herein.

Referring to FIG. 16, each of outermost partition walls 120c in the surface light source device 100c of the present embodiment includes a first partition wall portion 122c in an outermost light-emitting region 142c, and a second partition wall portion 124c in an outermost non-light-emitting region 144c and having a width narrower than that of the first partition wall portion 122b.

Space-expanding portions of the present embodiment are not provided to an inner face of the sealing member 130. The space-expanding portions are only provided to an outer face of the second partition wall portion 124c. Thus, each of the outermost discharge spaces 140c includes the outermost light-emitting region 142c having a first width W1, and the outermost non-light-emitting region 144c having a second width W3 wider than the first width W1. Alternatively, the outermost non-light-emitting region 144c may have a second height higher than a first height of the outermost light-emitting region 142c.

Here, in the present embodiment, the partition wall-separated type surface light source device 100c is exemplarily illustrated. Alternatively, the surface light source device 100c may correspond to the partition wall-integrated type. Further, the above-mentioned structures in Embodiments may be employed in the space-expanding portions of the present embodiment.

### Embodiment 7

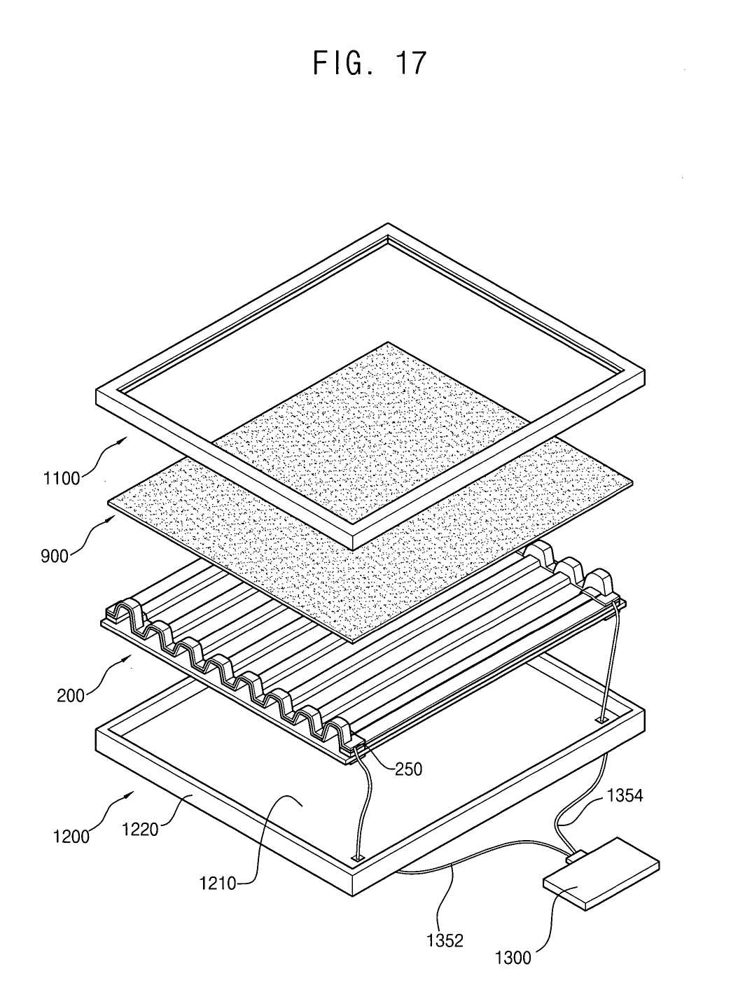

FIG. 17 is an exploded perspective view illustrating a backlight unit in accordance with a seventh embodiment of the present invention.

Referring to FIG. 17, a backlight unit 1000 in accordance with the present embodiment includes the surface light source device 200 in FIG. 8, upper and lower cases 1100 and 1200, an optical sheet 900 and an inverter 1300.

The surface light source device 200 is illustrated in detail with reference to FIG. 8. Thus, any further illustrations of the surface light source device 200 are omitted. Further, other surface light source devices in accordance with other Embodiments may be employed in the backlight unit 1000.

The lower case 1200 includes a bottom face 1210 for receiving the surface light source device 200, and a side face 1220 extending from an edge of the bottom face 1210. Thus, a receiving space for receiving the surface light source device 200 is formed in the lower case 1200.

The inverter 1300 is arranged under the lower case 1200. The inverter 1300 generates a discharge voltage for driving the surface light source device 200. The discharge voltage generated from the inverter 1300 is applied to the electrode 250 of the surface light source device 200 through first and second electrical cables 1352 and 1354.

The optical sheet 900 includes a diffusion sheet (not shown) for uniformly diffusing a light irradiated from the surface light source device 200, and a prism sheet (not shown) for providing straightforwardness to the light diffused by the diffusion sheet.

The upper case 1100 is combined with the lower case 1220 to support the surface light source device 200 and the optical sheet 900. The upper case 1100 prevents the surface light source device 200 from being separated from the lower case 1200.

Additionally, an LCD panel (not shown) for displaying an image may be arranged over the uppercase 1100.

According to the present invention, the non-light-emitting region has a cross sectional area larger than that of the light-emitting region due to the space-expanding portions of the light source body. Thus, a large amount of the discharge gas may be distributed in the non-light-emitting region than in the light-emitting region so that a relatively large number of secondary electrons may be generated in the non-light-emitting region. As a result, the light-emitting efficiency in the non-light-emitting region may be improved so that the electrode may not serve as a dark field and the surface light source device may have a long life span.

Having described the exemplary embodiments of the present invention and its advantages, it is noted that various changes, substitutions and alterations can be made herein without departing from the spirit and scope of the invention as defined by appended claims.

What is claimed is:

1. A surface light source device comprising:
a light source body having a plurality of discharge spaces into which a discharge gas is injected, each of the discharge spaces being divided into a light-emitting region that has a first cross sectional area, and a non-light-emitting region that has a second cross sectional area larger than the first cross sectional area; and
an electrode provided to the light source body to apply a voltage to the discharge gas.

2. The surface light source device of claim 1, wherein the non-light-emitting region has a width wider than that of the light-emitting region.

3. The surface light source device of claim 1, wherein the non-light-emitting region has a height higher than that of the light-emitting region.

4. The surface light source device of claim 1, wherein the non-light-emitting region has a width wider than that of the light-emitting region and a height higher than that of the light-emitting region.

5. The surface light source device of claim 1, wherein the electrode is formed on both outer end portions of the light source body.

6. The surface light source device of claim 5, wherein auxiliary electrodes extend from both ends of the electrode.

7. The surface light source device of claim 1, wherein outermost non-light-emitting regions among the non-light-emitting regions have a third cross sectional area larger than the second cross sectional area.

8. The surface light source device of claim 1, wherein the light source body comprises:
a first substrate;
a second substrate positioned over the first substrate and having space-expanding portions that provides the non-light-emitting region with the second cross sectional area;
a sealing member interposed between the first and second substrates to define an inner space isolated from the exterior; and
partition walls arranged in the inner space along a direction substantially perpendicular to the electrode to define the discharge spaces.

9. The surface light source device of claim 8, wherein each of the partition walls comprises:
a first partition wall portion positioned in the light-emitting region; and
a second partition wall portion positioned in the non-light-emitting region and having a width narrower than that of the first partition wall portion to provide the non-light-emitting region with a width wider than that of the light-emitting region.

10. The surface light source device of claim 8, wherein auxiliary space-expanding portions having a cross sectional area larger than that of the space-expanding portion extend from portions of the second substrate that define outermost discharge spaces among the discharge spaces.

11. The surface light source device of claim 1, wherein the light source body comprises:
a first substrate having space-expanding portions that provides the non-light-emitting region with the second cross sectional area;
a second substrate positioned over the first substrate;
a sealing member interposed between the first and second substrates to define an inner space isolated from the exterior; and
partition walls arranged in the inner space along a direction substantially perpendicular to the electrode to define the discharge spaces.

12. The surface light source device of claim 11, wherein auxiliary space-expanding portions having a cross sectional area larger than that of the space-expanding portion extend from portions of the first substrate, the portions of the first substrate defining outermost discharge spaces among the discharge spaces.

13. The surface light source device of claim 1, wherein the light source body comprises:
a first substrate; and
a second substrate positioned over the first substrate and integrally formed with partition walls that are arranged along a direction substantially perpendicular to the electrode to define the discharge spaces, the second substrate having space-expanding portions that provides the non-light-emitting region with the second cross sectional area.

14. The surface light source device of claim 13, wherein each of the partition wall portions comprises:
a first partition wall portion positioned in the light-emitting region; and
a second partition wall portion positioned in the non-light-emitting region and having a width narrower than that of the first partition wall portion to provide the non-light-emitting region with a width wider than that of the light-emitting region.

15. The surface light source device of claim 13, wherein auxiliary space-expanding portions having a cross sectional area larger than that of the space-expanding portion extend from portions of the second substrate, the portions of the second substrate defining outermost discharge spaces among the discharge spaces.

16. The surface light source device of claim 1, wherein the light source body comprises:
a first substrate having space-expanding portions to provide the non-light-emitting region with the second cross sectional area; and
a second substrate positioned over the first substrate and integrally formed with partition walls that are arranged along a direction substantially perpendicular to the electrode to define the discharge spaces.

17. The surface light source device of claim 16, wherein auxiliary space-expanding portions having a cross sectional area larger than that of the space-expanding portion extend from portions of the first substrate that define outermost discharge spaces among the discharge spaces.

18. A surface light source device comprising:
a light source body having central discharge spaces and outermost discharge spaces into which a discharge gas is injected, each of the central discharge spaces being divided into a central light-emitting region and a central non-light-emitting region having a width substantially identical to that of the central light-emitting region, each of the outermost discharge spaces being divided into an outermost light-emitting region that has a first cross sectional area and an outermost non-light-emitting region that has a second cross sectional area larger than the first cross sectional area; and
an electrode provided to the light source body to apply a voltage to the discharge gas.

19. The surface light source device of claim 18, wherein the light source body comprises:
a first substrate;
a second substrate positioned over the first substrate;
a sealing member interposed between the first and second substrates to define an inner space isolated from the exterior; and
partition walls arranged in the inner space along a direction substantially perpendicular to the electrode to define the central discharge spaces and the outermost discharge spaces,
wherein space-expanding portions for defining the outermost non-light-emitting region are formed at outer faces of outermost partition walls among the partition walls.

20. The surface light source device of claim 19, wherein the space-expanding portions are formed at inner faces of the sealing member.

21. The surface light source device of claim 19, wherein the partition walls are integrally formed with the second substrate.

22. A backlight unit comprising:
a surface light source device including a light source body having a plurality of discharge spaces into which a discharge gas is injected, and an electrode provided to the light source body to apply a voltage to the discharge gas, each of the discharge spaces being divided into a light-emitting region that has a first cross sectional area, and a non-light-emitting region that has a second cross sectional area larger than the first cross sectional area;
a case for receiving the surface light source device;
an optical sheet interposed between the surface light source device and the case; and
an inverter for applying a discharge voltage to the electrode of the surface light source device.
